(19) United States
(12) Patent Application Publication
(10) Pub. No.: US 2014/0143009 A1
(43) Pub. Date: May 22, 2014

(54) RISK REWARD ESTIMATION FOR COMPANY-COUNTRY PAIRS

(71) Applicant: INTERNATIONAL BUSINESS MACHINES CORPORATION, Armonk, NY (US)

(72) Inventors: Carla Brice, Danbury, CT (US); Wesley M. Gifford, New Canaan, CT (US); Krishna Ratakonda, Yorktown Heights, NY (US); Natalia Ruderman, Larchmont, NY (US)

(73) Assignee: INTERNATIONAL BUSINESS MACHINES CORPORATION, Armonk, NY (US)

(21) Appl. No.: 13/678,545

(22) Filed: Nov. 16, 2012

(51) Int. Cl. G06Q 10/06

(52) U.S. Cl. CPC G06Q 10/0635
USPC 705/7.28

(57) ABSTRACT

The reward or return a company receives in a particular country relative to the risk the company takes in that country is assessed. The relative risk of the particular country compared to selected groups of countries, for example groups including countries having emerging or developing economies and groups including countries having developed economies. The relative profitability of the particular country in relation to the profitability of such groups of countries is further considered in the assessment. Other return components are also considered to allow risk adjusted decisions.

### FIELD

The present invention relates to the electrical, electronic and computer arts, and, more particularly, to the assessment of relative risk and reward relating to operating in countries, regions, states and the like.

### BACKGROUND

Assessments of risk and/or reward have been conducted in various business environments.

A data driven and forward looking risk and reward appetite methodology for consumer and small business is described, for example, in U.S. Pat. No. 7,765,139. The methodology includes customer segmentation to create pools of homogeneous assets in terms of revenue and loss characteristics, forward looking simulation to forecast expected values and volatilities of revenue and loss, and risk and reward optimization of the portfolio. One methodology used for modeling revenue and loss is a generalized additive effect decomposition model to fit historical data. Based on the model, a segmentation procedure is performed, which allows for creation of groups of customers with similar revenue and loss characteristics. An estimation procedure for the model is developed and a simulation strategy to forecast and simulate revenue and loss volatility is developed. Efficient frontier curves of risk (e.g., return volatility) and reward (e.g. expected return) are created for the current portfolio under various economic scenarios. This method projects revenue and losses of customer and small business loan portfolios and uses an efficient frontier curve to identify the optimal match of risk and reward, where risk is minimized and return is optimized. In this case, risk is defined as volatility of returns, and reward is defined as the expected returns. The volatility or standard deviation from the mean is a measure of risk, but it is a measure of risk not entirely independent of the returns. In addition, expected returns requires a subject matter expert to assign probability to the results, which introduces subjectivity into the reward assessment.

Another example of a risk and reward assessment is disclosed in U.S. Pub. No. 2010/0114622 wherein systems and methods are disclosed for assessing a relocation option. More specifically, a line of business may assess a relocation option by generating a geographic model that may be based on data about a relocation option. The system and method of generating a geographic model may include the generation of a reward score based on reward drivers. The model may also include generating a risk score that is based on risk factors. The reward score and the risk score may be compared. The line of business may also conduct an in-country/due diligence visit based at least in part on the geographic model and may assemble a risk mitigation framework. In addition, outputs of the model may be analyzed using portfolio theory analysis. Such portfolio theory analysis may include determining the Markowitz Efficient Frontier of optimal location sets. The analysis may also include obtaining an optimal location set based on a preferably predetermined concentration risk tolerance. The disclosed method seeks to identify the optimal geographical location for a business process. A geographical model for the relocation option is developed using an internal and external assessment of the relocation option. Risk score drivers and reward score drivers are identified. An efficient frontier curve is used to identify the right mix of risk and reward. In this method, the subject matter expert identifies the internal factors that may be risk score drivers or reward score drivers. In addition, risk mitigation actions can be introduced to enhance the appeal of a relocation option.

The PRS Group provides an online service (www.prsgroup.com) that assesses country risk. The Coplin-O'Leary Country Risk Rating System uses seventeen risk components (twelve in the eighteen month forecast and five in the five year forecast) to assess country risk. The service provides a decision-focused political risk model with three industry forecasts at the micro level. The PRS system forecasts risk for investors in two stages, first identifying the three most likely future regime scenarios for each country over two time periods and then by assigning a probability to each scenario over each time period. For each regime scenario, PRS establishes likely changes in the level of political turmoil and eleven types of government intervention that affect the business climate. After calculating consolidated scores for all regimes, the PRS system converts these numbers into letter grades for three investment areas: financial transfers (banking and lending), foreign direct investment (e.g. retail, manufacturing, mining), and exports to the host country market. PRS' system provides only industry specific forecasts, not a generic macro level assessment. Users can customize the PRS forecasting model to individual projects or the particular exposures of a firm with an optional weighting system, adding or subtracting variables and adjusting the model to fit specific firm or project attributes. PRS Country Reports forecast the risk of doing business in one hundred countries and provides updates. Companies can use the information provided by PRS to assess risks within a country.

### SUMMARY

Principles of the disclosed embodiments provide techniques and systems for risk-reward estimation for company-country pairs. In one aspect, an exemplary method includes the steps of: i) obtaining a first sub-score based on a first risk multiple and a normalized gross profit margin coverage ratio, the risk multiple being based on an operational risk value of a country compared to a revenue-weighted average operational risk value profile of a first market comprising a selected group of countries, the normalized gross profit margin coverage ratio being based on a gross profit of the country compared to a first gross profit of the first market during a selected time period; ii) obtaining a second sub-score based on a second risk multiple and a second normalized gross profit margin coverage ratio, the risk multiple being based on the operational risk value of the country compared to a revenue-weighted average operational risk value profile of a second market comprised of a second selected group of countries different from the first selected group of countries, the second normalized gross profit margin coverage ratio being based on the gross profit of the country compared to second gross profit of the second market during the selected time period; iii) obtaining a third sub-score based on differences between gross profits associated with a business line of a company with gross profits of the business line in the first and second markets; iv) obtaining a fourth sub-score based on a change in exchange rate of a currency in the country; v) obtaining a fifth sub-score based on the country's return on equity, the returns on equity in the first and second markets, and the company's weighted average cost of capital, and vi) computing an overall risk-reward score based on the first, second, third, fourth and fifth sub-scores.

An apparatus provided herein includes a memory and at least one processor, coupled to said memory, and operative to: i) obtain a first sub-score based on a first risk multiple and a normalized gross profit margin coverage ratio, the risk multiple being based on an operational risk value of a country compared to a revenue-weighted average operational risk value profile of a first market comprising a selected group of countries, the normalized gross profit margin coverage ratio being based on a gross profit of the country compared to a first gross profit of the first market during a selected time period; ii) obtain a second sub-score based on a second risk multiple and a second normalized gross profit margin coverage ratio, the risk multiple being based on the operational risk value of the country compared to a revenue-weighted average operational risk value profile of a second market comprised of a second selected group of countries different from the first selected group of countries, the second normalized gross profit margin coverage ratio being based on the gross profit of the country compared to second gross profit of the second market during the selected time period; iii) obtain a third sub-score based on differences between gross profits associated with a business line of a company with gross profits of the business line in the first and second markets; iv) obtain a fourth sub-score based on a change in exchange rate of a currency in the country; v) obtain a fifth sub-score based on the country's return on equity, the returns on equity in the first and second markets, and the company's weighted average cost of capital, and vi) compute an overall risk-reward score based on the first, second, third, fourth and fifth sub-scores.

A computer program product is also provided in accordance with a further aspect. The product comprises a non-transitory computer readable storage medium having computer readable program code embodied therewith, said computer readable program code comprising: i) computer readable program code configured to obtain a first sub-score based on a first risk multiple and a normalized gross profit margin coverage ratio, the risk multiple being based on an operational risk value of a country compared to a revenue-weighted average operational risk value profile of a first market comprising a selected group of countries, the normalized gross profit margin coverage ratio being based on a gross profit of the country compared to a first gross profit of the first market during a selected time period; ii) computer readable program code configured to obtain a second sub-score based on a second risk multiple and a second normalized gross profit margin coverage ratio, the risk multiple being based on the operational risk value of the country compared to a revenue-weighted average operational risk value profile of a second market comprised of a second selected group of countries different from the first selected group of countries, the second normalized gross profit margin coverage ratio being based on the gross profit of the country compared to second gross profit of the second market during the selected time period; iii) computer readable program code configured to obtain a third sub-score based on differences between gross profits associated with a business line of a company with gross profits of the business line in the first and second markets; iv) computer readable program code configured to obtain a fourth sub-score based on a change in exchange rate of a currency in the country; v) computer readable program code configured to obtain a fifth sub-score based on the country's return on equity, the returns on equity in the first and second markets, and the company's weighted average cost of capital, and vi) computer readable program code configured to compute an overall risk-reward score based on the first, second, third, fourth and fifth sub-scores.

An apparatus in accordance with a further embodiment includes a memory and at least one processor coupled to the memory. The processor is operative to determine a first risk multiple, the first risk multiple being based on an operational risk value of a country compared to a revenue-weighted average operational risk value profile of a first market comprising a first selected group of countries and determine a first normalized gross profit margin coverage ratio based on a gross profit margin of the country compared to a first gross profit margin of the first market during a selected time period. The processor is further operative to determine a second risk multiple, the second risk multiple being based on the operational risk value of the country compared to a revenue-weighted average operational risk value profile of a second market comprising a second selected group of countries and to determine a second normalized gross profit margin coverage ratio based on the gross profit of the country compared to a second gross profit of the second market during the selected time period. The process is further operative to compare gross profit margins associated with a business line of the company with gross profit margins of the business line in the first and second markets, compare the country's return on equity with the returns on equity in the first and second markets and the company's weighted average cost of capital, and compute an overall risk-reward score based on the first risk multiple, the first normalized gross profit margin coverage ratio, the second risk multiple, the second normalized gross profit margin coverage ratio, the comparison of the gross profit margins associated with the business line of the company with gross profit margins of the business line in the first and second markets, and the comparison of the country's return on equity with the returns on equity in the first and second markets and the company's weighted average cost of capital.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques of the present invention can provide substantial beneficial technical effects. For example, one or more embodiments may provide one or more of the following advantages:

Objective assessment of a country's risk versus a basket of other countries;

Risk-reward estimation for company-country pairs;

Objective assessment of both risk and reward facilitates management decisions.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 shows a graph illustrating a risk/reward sub-curve, demonstrating how a country's risk and reward profile compares against the benchmark and the resulting subscore;

FIG. 2 depicts a computer system that may be useful in implementing one or more aspects and/or elements of the invention, and

FIG. 3 shows a flow diagram showing an exemplary method of estimating the reward or return a company is likely to receive relative to the risk of operating in a particular country.

### DETAILED DESCRIPTION

As companies seek higher returns for shareholders, they may ultimately assume more risks. Companies need a method to assess whether the amount of risk assumed is reasonable given the expected or actual returns. This will help safeguard shareholders against excessive risk taking. Due to historical and projected economic growth trends in advanced economies versus emerging and developing economies, business leaders may see the prospect of growth as limited in advanced economies. In order to achieve additional growth, executives may look to the emerging and developing world. However, this could potentially lead to more risk to operational and financial success. A method that is objective, standardized, and repeatable so that risk and reward can be monitored over time across a country portfolio would accordingly benefit shareholders and/or other persons or entities having an interest in the success of a company. The method and system introduced in this disclosure is objective, defines a standardized set of factors as risk across a country portfolio, uses actual, real-time results to define reward, can be repeated to compare a country or set of countries over time, and can be applied to any globally integrated company.

A system and method for assessing the reward or return a company receives in a particular country relative to the risk a company is taking by operating in that country on an ongoing basis is provided in accordance with one or more exemplary embodiments. Specifically, the relative risk of the country to emerging and developing countries and developed or mature countries is quantified. Additionally, the relative profitability of the country in relation to the profitability of emerging and developing countries, as well as developed or mature countries is calculated. Other return components are considered in the methodology to determine the return of the country's business to, for example, a parent company. An objective is to characterize the risk-reward on an ongoing basis to provide management the information necessary to make risk adjusted decisions. The method and system provided herein is, defines a standardized set of factors as risk across a country portfolio, uses actual, real-time results to define reward, and can be repeated to compare a country, region or set of countries over time. The term “country” as employed herein includes a sovereign nation, a region that may include more than one sovereign nation, a territory forming all or part of a sovereign nation, or other geographical area in which relevant economic information is obtainable.

An exemplary method looks at five sub-scores to determine the overall risk reward score. Each of the sub-scores and the overall risk-reward scores are continuous, meaning the value can be anywhere from 0 to 1. The closer the score is to 1, the higher the risk. As an example, to demonstrate the methodology, two countries, Country A and Country B, are analyzed for a quarterly calendar period. Country A has a developing economy while Country B has a developed economy in the example. Sub-scores above, for example, 0.500 are considered high risk. Sub-scores of 0.250 or less are considered low risk.

| Calendar Quarter 3 | Country A | Country B |
|---|---|---|
| 1. Growth Market Compare | 0.617 | 0.213 |
| 2. Major Market Compare | 0.895 | 0.477 |
| 3. Line of Business Compare | 0.250 | 0.250 |
| 4. Currency Fluctuation | 0.000 | 0.000 |
| 5. Return on Equity | 0.034 | 0.689 |
| Risk/Reward | 0.359 | 0.326 |

The overall Risk/Reward score is given by:

$$R = \frac{1}{5} [ \frac{1}{π} Arc Tan ( {a}_{4} ( {P}_{GMU} - {E}_{GMJ} ) ) - \frac{1}{2} + \frac{1}{π} Arc Tan ( {a}_{4} ( {P}_{MM} - {E}_{MM} ) ) - \frac{1}{2} + \frac{1}{2 N} [ {\sum }_{j = 1}^{N} u ( {GP}_{GMU}^{( j )} - {GP}^{( j )} ) + {\sum }_{j = 1}^{N} u ( {GP}_{MM}^{( j )} - {GP}^{( j )} ) ] + [ u ( 100 ( \frac{χ}{{χ}_{0}} - 1 ) ) - u ( 100 ( \frac{χ}{{χ}_{0}} - 1 ) - 10 ) ] sin ( \frac{π}{20} 100 ( \frac{χ}{{χ}_{0}} - 1 ) ) + u ( 100 ( \frac{χ}{{χ}_{0}} - 1 ) - 10 ) + \frac{1.1}{π} Arc Tan ( \frac{1}{20} ( v - {η}^{*} + \frac{1}{2} ( {η}_{GMU} + {η}_{MM} ) - {η}^{*} ) ) + \frac{1}{2} ]$$

Each row in the formula above corresponds to a particular sub-score. The overall risk reward is an average of the transformed versions of the underlying metrics. The transformation consists of mapping the underlying risk and reward variables to a logical score in the range of 0 to 1, thus it puts the variables on a similar scale and allows the individual sub-scores to be combined. Additional details about each of the formulas used in the risk reward algorithm are provided below, with references to the flow diagram shown in FIG. 3.

### 1. Growth Market Compare

Growth Markets are developing and emerging economy countries as opposed to advanced economy countries such as the United States, Canada and Germany. A single country is compared to the countries in the Growth Markets to assess sub-score 1 in step as shown in FIG. 3. In order to calculate this sub-score, two variables are needed, the risk multiple E_{GMU} and the normalized gross profit margin coverage ratio, P_{GMU}.

The operational risk of the country, as measured by an independent entity, is compared to the revenue-weighted average operational risk profile of the Growth Market countries suing the formula E_{GMU}=ρ*/ρ_{GMU}, where ρ* is the operational risk of the country and ρ_{GMU} is the revenue weighted operation risk profile of the GMU. Operational risks include nonfinancial risk that a company must address in order to successfully do business in that country. Operational risks may include items such as security risk and/or legal and regulatory risk. The independent entity is a risk reporting agency. For example, if Country A's end of period 3Q 2011 independent risk score is 47, and the Country B's score is 22, then Country A is higher risk than the Country B from an external perspective. If the revenue weighted average risk score of the Growth Markets is 37.4, Country A is 1.2× (47/37.4) or more risky, while the Country B is 0.6× (22/37.4) or less risky.

The second portion of the sub-score considers gross profitability of the same time period. The formula used for this portion is:

$${P}_{GMU} = \frac{{GP}^{*}}{{GP}_{GMU}}$$

where GP* is the gross profit margin of the country and GP_{GMU} is the growth profit margin of countries in the GMU (Growth Market Unit). The gross profit margin (gross profit/revenue) is normalized for the revenue mix of the Growth Market countries. Normalization makes the line of business revenue mix of all countries equal to the Growth Markets' revenue mix. This prevents comparing the overall gross profit margin of a country that derives revenue primarily from high margin businesses, like software, to a country with revenue derived primarily from lower margin businesses like hardware. If normalization were not done, the country with the higher mix of higher margin businesses would obviously score better. After normalization, the actual gross margins realized in the country are applied to the normalized revenue mix to determine a normalized gross profit margin. For Country A, the gross profit margin of 55% when normalized was 56%. For Country B, the gross profit margin of 52% when normalized was 50%. The Growth Market's gross profit margin was 50%, producing a normalized gross profit margin coverage of 1.1× for Country A and 1.0× (50%/50%) for Country B.

Using these two variables, the gross profit margin ratio and the risk multiple, the value of this sub-score is computed as:

$${s}_{1} = \frac{1}{π} Arc Tan ( {a}_{4} ( {P}_{GMU} - {E}_{GMJ} ) ) - \frac{1}{2}$$

where the quantity a₄ is a calculated constant. In this example, Country A's score is 0.62 or 62%, and is 1.2× as risky as the Growth Markets, but there is a profitability gap that produces a higher risk score. Country B's low risk sub-score shows that it is less risky but very profitable when compared to the benchmark.

### 2. Major Markets Compare

The term Major Market as employed herein refers to relatively advanced economies. A single country is compared in step 12 to the total number of countries in the Major Market basket to assess risk reward sub-score 2. The operational risk of the country (ρ*), as measured by an independent entity, is compared to the revenue-weighted average operational risk profile of the Major Market countries (ρ_{MM}), using the formula: E_{MM}=ρ*/ρ_{MM}. This produces the risk multiple Major Market compare. Similarly, the profit margin coverage ratio is generated using the formula P_{MM}=GP*/GP_{MM}. For the exemplary time period, Country A's independent risk score is 47 while Country B's score is 22. The denominator is the weighted average risk score of the Major Market, which is 22.3 in this exemplary embodiment. Country A's risk multiple is 2.0× and Country B's multiple is 0.98×. Country A's gross profit margin is 54.1% when normalized, a coverage ratio of 1.1× when compared to the gross profit margin of the Major Market. Country B's gross profit margin is 49.1% when normalized, a coverage ratio of 1.0× when compared to the gross profit margin of the Major Market. Using these two variables, the gross profit margin ratio and the risk multiple, the value of this sub-score is computed as: s=1/π ArcTan(a₄(P_{MM}−E_{MM}))−½ where the quantity a₄ is a calculated constant. Country A's score is 0.89 or 89%; its substantially higher risk profile is not offset by its profitability. Country B's score is 0.48 or 48%; the risk and reward are almost equal, thus yielding a risk score close to 0.5.

### 3. Line of Business Gross Margins Compare

Absolute pricing or gross margins by line of business are also considered in step 14 of the exemplary embodiment. In this sub-score, the line of businesses within the company, e.g. hardware, software, services, and other are compared against the absolute gross margins in the Growth Markets (GP^{(j)}−GP_{GMU}^{(j)}) and Major Markets (GP^{(j)}−GP_{MM}^{(j)}). Here, G^{(j)}) represents the gross profit margin of the business line. Four business lines (hardware HW, software SW, Services and Other) are considered in the exemplary embodiment, it being understood that fewer or more business lines and/or different business lines may be considered in accordance with the present disclosure. Points are assigned when a country has a lower margin than the Growth Markets and/or the Major Markets. The table below outlines the gross profit margins by line of business for the Country A and the Country B when compared to the Major Market and Growth Markets. In the case of Country A, software margins are less than both the Growth and Major Markets. In the case of Country B, hardware and services margins are less than the Growth Markets. Both countries have two instances where margins fall short of the benchmarks, and both countries gather two of eight available points in this sub-score.

| | | | | | | NORM | NORM |
|---|---|---|---|---|---|---|---|
| Calendar | HW | SW | SERVICES | OTHER | TOTAL | GPM | GPM |
| Quarter 3 | GPM | GPM | GPM | GPM | GPM | GMU | MAJOR |
| COUNTRY A | 50.6% | 96.8% | 34.6% | 77.7% | 54.6% | 55.7% | 54.1% |
| COUNTRY B | 43.9% | 98.1% | 27.9% | 70.5% | 52.3% | 50.5% | 49.1% |
| MAJOR | 42.3% | 97.4% | 27.8% | 70.0% | 48.7% | 48.7% | — |
| MARKETS | | | | | | | |
| GROWTH | 44.0% | 97.4% | 29.3% | 63.8% | 50.2% | — | 50.2% |
| MARKETS | | | | | | | |

The formula used to capture this data is as follows:

$${s}_{3} = \frac{1}{2 N} [ {\sum }_{j = 1}^{N} u ( {GP}_{GMU}^{( j )} - {GP}^{( j )} ) + {\sum }_{j = 1}^{N} u ( {GP}_{MM}^{( j )} - {GP}^{( j )} ) ] .$$

In this formula, u(•) is the unit step function.

### 4. Currency Devaluation/Strength

The year to year change in the exchange rate is the input in step 16 for this sub-score. The financial results are less valuable if a foreign currency devalues with respect to the home country's currency. In this exemplary embodiment, the exchange rate is defined as the unit of currency per Country B currency unit. The input to the sub-score formula is as follows: l₄=χ/χ₀−1 where χ is the current exchange rate and χ₀ is the previous exchange rate.

In the case of Country B, the exchange rate is flat year to year at 1 to 1. For Country A, the A-currency unit was 6.4/B-currency unit in the third calendar quarter of the present year versus 6.8/B-currency unit in the third quarter of the prior year. Since less A-currency units are needed to purchase a B-currency unit in the third quarter of the present year versus the third quarter of the prior year, the currency did not depreciate, but appreciated year to year. When the YTY percentage of 5.18% is input into the sub-score formula, the sub-score is 0. The formula used is as follows:

$${s}_{4} = [ u ( 100 ( \frac{χ}{{χ}_{0}} - 1 ) ) - u ( 100 ( \frac{χ}{{χ}_{0}} - 1 ) - 10 ) ] sin ( \frac{π}{20} 100 ( \frac{χ}{{χ}_{0}} - 1 ) ) + u ( 100 ( \frac{χ}{{χ}_{0}} - 1 ) - 10 )$$

### 5. Return on Equity (ROE) Compare

Return on equity is the country's net income divided by the average equity. For simplicity, average equity is a two point average. Net income is cumulative or year to date, and the ROE is annualized. The country's ROE is compared to the ROE of the Growth Markets, Major Markets, and the firm's weighted average cost of capital (WACC) in step 18. This establishes WACC as the hurdle rate. In the present example, for the present calendar third quarter, Country A's ROE was 56.1%. Country B's ROE was 9.4%. The Growth Markets and the Major Markets ROE was 24% and 13.1%, respectively. WACC was 11.5%. The following formula is used:

$${s}_{5} = \frac{1.1}{π} Arc Tan ( \frac{1}{20} ( v - {η}^{*} + \frac{1}{2} ( {η}_{GMU} + {η}_{MM} ) - {η}^{*} ) ) + \frac{1}{2}$$

where v is the cost of capital and η*, η_{GMU} and η_{MM} are the ROE in the target country, GMU, and Major Market, respectively. Using this formula, Country A's sub-score is 0.034 and Country B's sub-score is 0.689.

### 6. Overall Risk/Reward Score

The overall risk reward score is computed in step 20 as a weighted average of the underlying components:

$$R = {\sum }_{i = 1}^{M} {ω}_{i} {s}_{i}$$

where the weights ωᵢ are such that

$${\sum }_{i = 1}^{M} {ω}_{i} = 1$$

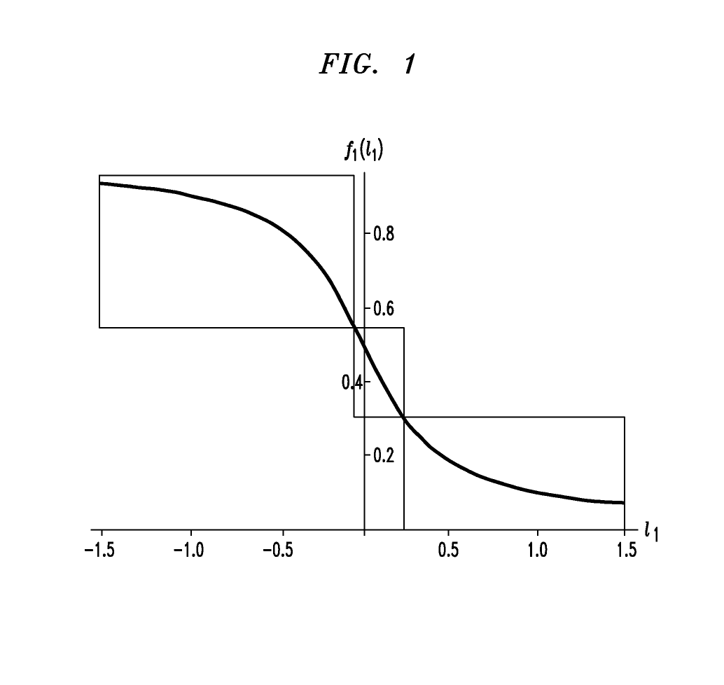

and can be determined based on a variety of factors. For example, the overall risk-reward score in one embodiment is calculated as the arithmetic average of the underlying components by setting ωᵢ=1/M, ∀i. (The expression ∀i means “for all”.) In alternative formulations, the weights are adjusted to account for the prior accuracy of the resulting score. In such a formulation, the weights of components determined to be more accurate are increased. An example of one of the sub-scores (sᵢ) is provided in FIG. 1, which shows an exemplary risk/reward subcurve that demonstrates how a country's risk and reward profile compares against a benchmark and the subscore resulting therefrom. The three rectangular areas appearing from left to right designate relatively high, medium and low risk sub-scores.

Given the discussion thus far, it will be appreciated that, in general terms, an exemplary apparatus includes a memory and at least one processor coupled to the memory. The processor is operative to: i) obtain a first sub-score based on a first risk multiple and a normalized gross profit margin coverage ratio, the risk multiple being based on an operational risk value of a country compared to a revenue-weighted average operational risk value profile of a first market comprising a selected group of countries, the normalized gross profit margin coverage ratio being based on a gross profit of the country compared to a first gross profit of the first market during a selected time period; ii) obtain a second sub-score based on a second risk multiple and a second normalized gross profit margin coverage ratio, the risk multiple being based on the operational risk value of the country compared to a revenue-weighted average operational risk value profile of a second market comprised of a second selected group of countries different from the first selected group of countries, the second normalized gross profit margin coverage ratio being based on the gross profit of the country compared to second gross profit of the second market during the selected time period; iii) obtain a third sub-score based on differences between gross profits associated with a business line of a company with gross profits of the business line in the first and second markets; iv) obtain a fourth sub-score based on a change in exchange rate of a currency in the country; v) obtain a fifth sub-score based on the country's return on equity, returns on equity in the first and second markets, and the company's weighted average cost of capital. The processor is further operative to compute an overall risk-reward score based on the first, second, third, fourth and fifth sub-scores.

An apparatus in accordance with a further embodiment includes a memory and at least one processor coupled to the memory. The processor is operative to determine a first risk multiple, the first risk multiple being based on an operational risk value of a country compared to a revenue-weighted average operational risk value profile of a first market comprising a first selected group of countries and determine a first normalized gross profit margin coverage ratio based on a gross profit margin of the country compared to a first gross profit margin of the first market during a selected time period. The processor is further operative to determine a second risk multiple, the second risk multiple being based on the operational risk value of the country compared to a revenue-weighted average operational risk value profile of a second market comprising a second selected group of countries and to determine a second normalized gross profit margin coverage ratio based on the gross profit of the country compared to a second gross profit of the second market during the selected time period. The process is further operative to compare gross profit margins associated with a business line of the company with gross profit margins of the business line in the first and second markets, compare the country's return on equity with the returns on equity in the first and second markets and the company's weighted average cost of capital, and compute an overall risk-reward score based on the first risk multiple, the first normalized gross profit margin coverage ratio, the second risk multiple, the second normalized gross profit margin coverage ratio, the comparison of the gross profit margins associated with the business line of the company with gross profit margins of the business line in the first and second markets, and the comparison of the country's return on equity with the returns on equity in the first and second markets and the company's weighted average cost of capital. A country of interest may or may not use the same currency as the home country's currency. In a further exemplary embodiment of the apparatus the processor is operative to compute the overall risk-reward ratio based further on a change in exchange rate relating to the country. The apparatus is thereby able to address environments in which currency rates are a potentially important factor.

### Exemplary System and Article of Manufacture Details

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

One or more embodiments of the invention, or elements thereof, can be implemented in the form of an apparatus including a memory and at least one processor that is coupled to the memory and operative to perform exemplary method steps.

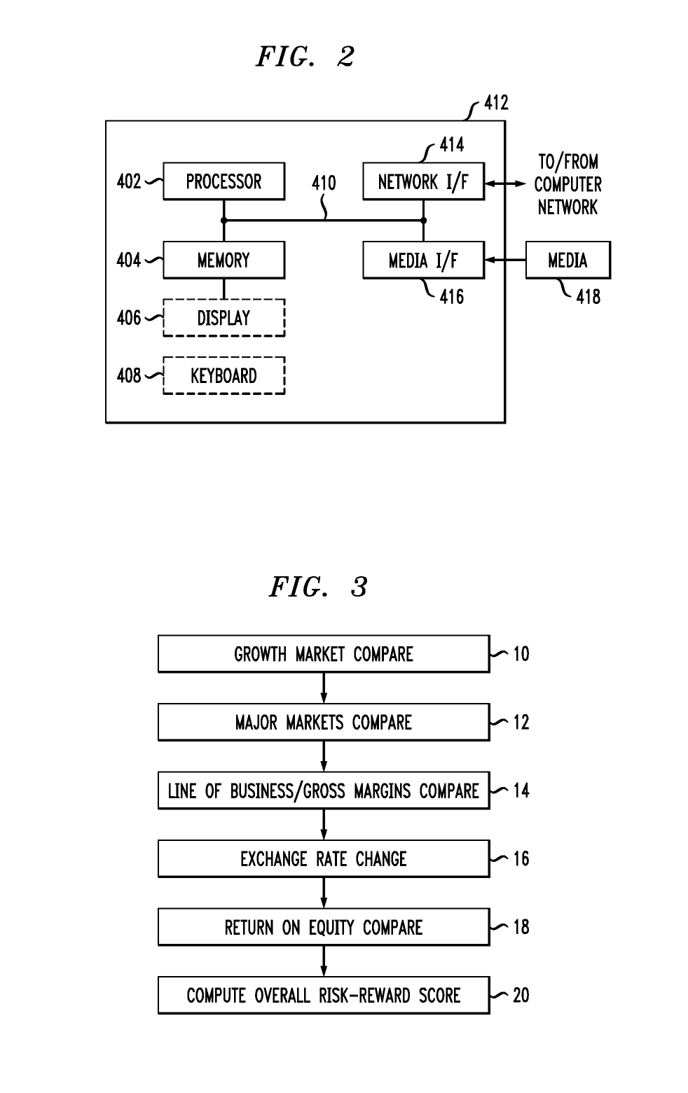

One or more embodiments can make use of software running on a general purpose computer or workstation. With reference to FIG. 2 such an implementation might employ, for example, a processor 402, a memory 404, and an input/output interface formed, for example, by a display 406 and a keyboard 408. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 402, memory 404, and input/output interface such as display 406 and keyboard 408 can be interconnected, for example, via bus 410 as part of a data processing unit 412. Suitable interconnections, for example via bus 410, can also be provided to a network interface 414, such as a network card, which can be provided to interface with a computer network, and to a media interface 416, such as a diskette or CD-ROM drive, which can be provided to interface with media 418.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 402 coupled directly or indirectly to memory elements 404 through a system bus 410. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 408, displays 406, pointing devices, and the like) can be coupled to the system either directly (such as via bus 410) or through intervening I/O controllers (omitted for clarity).

Network adapters such as network interface 414 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 412 as shown in FIG. 4) running a server program. It will be understood that such a physical server may or may not include a display and keyboard.

As noted, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Media block 418 is a non-limiting example. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. A non-transitory computer readable medium may embody instructions executed by the processor to perform estimation of the risk and reward of operation in a particular country as described above.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams and/or described herein; by way of example and not limitation, a growth market compare module, a major market compare module, a gross margins compare module, a currency exchange module, and a ROE compare module. The method steps 10-18 can then be carried out using the distinct software modules and/or sub-modules of the system, as described above, executing on one or more hardware processors 402. Further, a computer program product can include a computer-readable storage medium with code adapted to be implemented to carry out one or more method steps described herein, including the provision of the system with the distinct software modules.

In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An apparatus comprising:
a memory; and
at least one processor, coupled to said memory, and operative to:
obtain a first sub-score based on a first risk multiple and a normalized gross profit margin coverage ratio, the risk multiple being based on an operational risk value of a country compared to a revenue-weighted average operational risk value profile of a first market comprising a selected group of countries, the normalized gross profit margin coverage ratio being based on a gross profit of the country compared to a first gross profit of the first market during a selected time period;
obtain a second sub-score based on a second risk multiple and a second normalized gross profit margin coverage ratio, the risk multiple being based on the operational risk value of the country compared to a revenue-weighted average operational risk value profile of a second market comprised of a second selected group of countries different from the first selected group of countries, the second normalized gross profit margin coverage ratio being based on the gross profit of the country compared to second gross profit of the second market during the selected time period;
obtain a third sub-score based on differences between gross profits associated with a business line of a company with gross profits of the business line in the first and second markets;
obtain a fourth sub-score based on a change in exchange rate of a currency in the country;
obtain a fifth sub-score based on the country's return on equity, the returns on equity in the first and second markets, and the company's weighted average cost of capital, and
compute an overall risk-reward score based on the first, second, third, fourth and fifth sub-scores.

2. The apparatus of claim 1, wherein the processor is further operative to compute the overall risk-reward score by determining a weighted average of the first, second, third, fourth and fifth sub-scores.

3. The apparatus of claim 1, further comprising a plurality of distinct software modules, each of the distinct software modules being embodied on a non-transitory computer-readable storage medium, and wherein the distinct software modules comprise a growth market compare module and a major markets compare module;
wherein:
said at least one processor is operative to obtain the first sub-score by executing said growth market compare module and obtain the second sub-score by executing on the major markets compare module.

4. The apparatus of claim 3, wherein the distinct software modules further comprise a gross margins compare module wherein:
said at least one processor is operative to obtain the third sub-score by executing on said gross margins compare module.

5. The apparatus of claim 4, wherein the distinct software modules further comprise a currency exchange rate module wherein:
said at least one processor is operative to obtain the fourth sub-score by executing on said currency exchange rate module.

6. A computer program product comprising a non-transitory computer readable storage medium having computer readable program code embodied therewith, said computer readable program code comprising:
computer readable program code configured to obtain a first sub-score based on a first risk multiple and a normalized gross profit margin coverage ratio, the risk multiple being based on an operational risk value of a country compared to a revenue-weighted average operational risk value profile of a first market comprising a selected group of countries, the normalized gross profit margin coverage ratio being based on a gross profit of the country compared to a first gross profit of the first market during a selected time period;
computer readable program code configured to obtain a second sub-score based on a second risk multiple and a second normalized gross profit margin coverage ratio, the risk multiple being based on the operational risk value of the country compared to a revenue-weighted average operational risk value profile of a second market comprised of a second selected group of countries different from the first selected group of countries, the second normalized gross profit margin coverage ratio being based on the gross profit of the country compared to second gross profit of the second market during the selected time period;
computer readable program code configured to obtain a third sub-score based on differences between gross profits associated with a business line of a company with gross profits of the business line in the first and second markets;
computer readable program code configured to obtain a fourth sub-score based on a change in exchange rate of a currency in the country;
computer readable program code configured to obtain a fifth sub-score based on the country's return on equity, the returns on equity in the first and second markets, and the company's weighted average cost of capital, and
computer readable program code configured to compute an overall risk-reward score based on the first, second, third, fourth and fifth sub-scores.

7. The computer program product of claim 6 wherein the computer readable program code configured to compute the overall risk-reward score is further configured to compute the overall risk-reward score by determining a weighted average of the first, second, third, fourth and fifth sub-scores.

8. An apparatus comprising:
a memory; and
at least one processor, coupled to said memory, and operative to:
determine a first risk multiple, the first risk multiple being based on an operational risk value of a country compared to a revenue-weighted average operational risk value profile of a first market comprising a first selected group of countries,
determine a first normalized gross profit margin coverage ratio based on a gross profit margin of the country compared to a first gross profit margin of the first market during a selected time period;
determine a second risk multiple, the second risk multiple being based on the operational risk value of the country compared to a revenue-weighted average operational risk value profile of a second market comprising a second selected group of countries,
determine a second normalized gross profit margin coverage ratio based on the gross profit of the country compared to a second gross profit of the second market during the selected time period;
compare gross profit margins associated with a business line of the company with gross profit margins of the business line in the first and second markets;
compare the country's return on equity with the returns on equity in the first and second markets and the company's weighted average cost of capital, and
compute an overall risk-reward score based on the first risk multiple, the first normalized gross profit margin coverage ratio, the second risk multiple, the second normalized gross profit margin coverage ratio, the comparison of the gross profit margins associated with the business line of the company with gross profit margins of the business line in the first and second markets, and the comparison of the country's return on equity with the returns on equity in the first and second markets and the company's weighted average cost of capital.

9. The apparatus of claim 8, wherein the processor is operative to compute the overall risk-reward ratio based further on a change in exchange rate relating to the country.
